(19) United States
(12) Patent Application Publication
(10) Pub. No.: US 2018/0209323 A1
(43) Pub. Date: Jul. 26, 2018

(54) FLOWPATH STRUCTURE

(71) Applicant: DENSO CORPORATION, Kariya-city, Aichi-pref. (JP)

(72) Inventor: Kouji TAKAHASHI, Kariya-city (JP)

(21) Appl. No.: 15/744,618

(22) PCT Filed: Oct. 25, 2016
(86) PCT No.: PCT/JP2016/081602

§ 371 Date: Jan. 12, 2018

(30) Foreign Application Priority Data
Oct. 29, 2015 (JP) 2015-213160

(51) Int. Cl. F01P 7/04; F16K 31/365; F16K 31/40

(52) U.S. Cl. CPC F01P 7/046; F01P 7/10; F16K 31/40; F16K 31/365

(57) ABSTRACT

A flowpath structure includes: a supply channel in which a fluid to be supplied to an apparatus flows; a discharge channel in which the fluid discharged from the apparatus flows; and a pilot type opening-and-closing valve disposed in either one channel of the supply channel and the discharge channel. The opening-and-closing valve has a main valve arranged in the either one channel, a pilot channel connecting the supply channel and the discharge channel with each other, a back pressure chamber defined in the pilot channel, and a pilot valve that opens and closes a portion of the pilot channel closer to the discharge channel than the back pressure chamber. The main valve opens and closes the either one channel based on a change in an internal pressure of the back pressure chamber caused by an opening-and-closing operation of the pilot valve.

### CROSS REFERENCE TO RELATED APPLICATION

This application is based on Japanese Patent Application No. 2015-213160 filed on Oct. 29, 2015, with claiming the benefit of priority, the disclosure of which is incorporated herein by reference.

### TECHNICAL FIELD

The present disclosure relates to a flowpath structure including a pilot type opening-and-closing valve.

### BACKGROUND ART

This kind of a flowpath structure is described in Patent Literature 1. In the flowpath structure of Patent Literature 1, a pilot type opening-and-closing valve is arranged in a middle of a channel. The opening-and-closing valve has a body, a diaphragm valve, a pilot valve, and an electromagnetic solenoid. An inflow passage, an outflow passage, a communicate way, and a pilot passage are formed in the body. The diaphragm valve intervenes between the inflow passage and the outflow passage of the body to open and close the passage. The communicate way communicates the inflow passage to a back pressure chamber of the diaphragm valve. The pilot passage communicates the back pressure chamber of the diaphragm valve to the outflow passage. The pilot valve opens and closes the pilot passage. The electromagnetic solenoid operates the pilot valve to open and close.

In the opening-and-closing valve of Patent Literature 1, when the pilot valve is in a closed state, water flows into the back pressure chamber of the diaphragm through the communicate way from the inflow passage. Then, the water pressure on the inflow passage side acts on the back pressure chamber of the diaphragm valve to close the diaphragm valve, such that the opening-and-closing valve is in the closed state.

Moreover, in the opening-and-closing valve of Patent Literature 1, when the pilot valve is in an open state, water flows out of the back pressure chamber and flows into the outflow passage through the pilot passage. Then, the internal pressure of the back pressure chamber of the diaphragm valve is lowered to open the diaphragm valve, such that the opening-and-closing valve is in the open state.

### PRIOR ART LITERATURES

### Patent Literature

Patent Literature 1: JP 2008-2641 A

### SUMMARY OF INVENTION

In an engine cooling system of a vehicle, a mechanical pump driven by the engine power makes heat medium which cools the engine to circulate in a radiator, a heater core, and the like. In case where the pilot type opening-and-closing valve of Patent Literature 1 is disposed in a channel for the heat medium in such an engine cooling system, a valve-closing operation of the opening-and-closing valve may not be performed appropriately. The details are as follows.

Since the engine revolving speed is changed according to the drive load, the output of the pump is also changed. For example, at a time of idling operation with slow engine revolving speed, the engine is a low load state. Since the output of the pump declines when the engine is a low load state, the pressure of the heat medium supplied to the opening-and-closing valve also declines. In the opening-and-closing valve of Patent Literature 1, the diaphragm valve is closed by a change in the pressure of the back pressure chamber caused by the closing operation of the pilot valve. When the pressure of the heat medium supplied to the opening-and-closing valve declines, the change in the pressure of the back pressure chamber becomes small. As a result, the valve-closing operation of the diaphragm valve may not be performed appropriately. The similar subject may be produced also when the diaphragm valve is opened.

It is an object of the present disclosure to provide a flowpath structure in which a pilot type opening-and-closing valve can more appropriately operate to open and close.

According to an aspect of the present disclosure, a flowpath structure includes: a supply channel in which a fluid to be supplied to an apparatus flows; a discharge channel in which the fluid discharged from the apparatus flows; and a pilot type opening-and-closing valve disposed in either one channel of the supply channel and the discharge channel. The opening-and-closing valve has a main valve arranged in the either one channel, a pilot channel connecting the supply channel and the discharge channel with each other, a back pressure chamber being defined in the pilot channel, and a pilot valve that opens and closes a portion of the pilot channel closer to the discharge channel than the back pressure chamber. The main valve opens and closes the either one channel based on a change in an internal pressure of the back pressure chamber caused by an opening-and-closing operation of the pilot valve.

Accordingly, when the pilot valve is open, the back pressure chamber is pressurized according to a pressure difference between the internal pressure of the supply channel and the internal pressure of the discharge channel. Since the apparatus acts as resistance to water flow, the internal pressure of the discharge channel is lowered by the resistance of the apparatus to water flow, as compared with the internal pressure of the supply channel. Therefore, compared with a case where the apparatus does not exist, the internal pressure of the back pressure chamber, when the pilot valve is open, can be reduced only by the resistance of the apparatus to water flow. Thereby, the change in the pressure of the back pressure chamber becomes larger when the pilot valve is closed from the open state and when the pilot valve is opened from the closed state. As a result, since the force applied to the main valve can be widely changed, the opening-and-closing operation of the opening-and-closing valve can be carried out more appropriately.

### BRIEF DESCRIPTION OF DRAWINGS

FIG. 1 is a block diagram illustrating a flowpath structure of an engine cooling system according to an embodiment.

FIG. 2 is a sectional view illustrating a cross-sectional structure around a pilot type opening-and-closing valve of the flowpath structure of the embodiment.

FIG. 3 is a sectional view illustrating the opening-and-closing valve when a pilot valve is closed in the flowpath structure of the embodiment.

FIG. 4 is a graph illustrating a relation of an internal pressure P1 at an upstream side connecting point in a third channel, an internal pressure P2 at an inflow port of a main valve, an internal pressure P3 of a back pressure chamber, an internal pressure P4 at an outlet port of the main valve, and an internal pressure P5 at a downstream side connecting point in a fourth channel in a situation where the pilot valve is closed in the flowpath structure of the embodiment.

FIG. 5 is a graph illustrating a relation of an internal pressure P1 at an upstream side connecting point in a third channel, an internal pressure P2 at an inflow port of a main valve, an internal pressure P3 of a back pressure chamber, an internal pressure P4 at an outlet port of the main valve, and an internal pressure P5 at a downstream side connecting point in a fourth channel in a situation where the pilot valve is open in the flowpath structure of the embodiment.

FIG. 6 is a block diagram illustrating a flowpath structure of an engine cooling system according to other embodiment.

FIG. 7 is a block diagram illustrating a flowpath structure of an engine cooling system according to other embodiment.

FIG. 8 is a block diagram illustrating a flowpath structure of an engine cooling system according to other embodiment.

### DESCRIPTION OF EMBODIMENTS

Hereafter, an embodiment is described in which a flowpath structure is for an engine cooling system of a vehicle. First, the engine cooling system is explained.

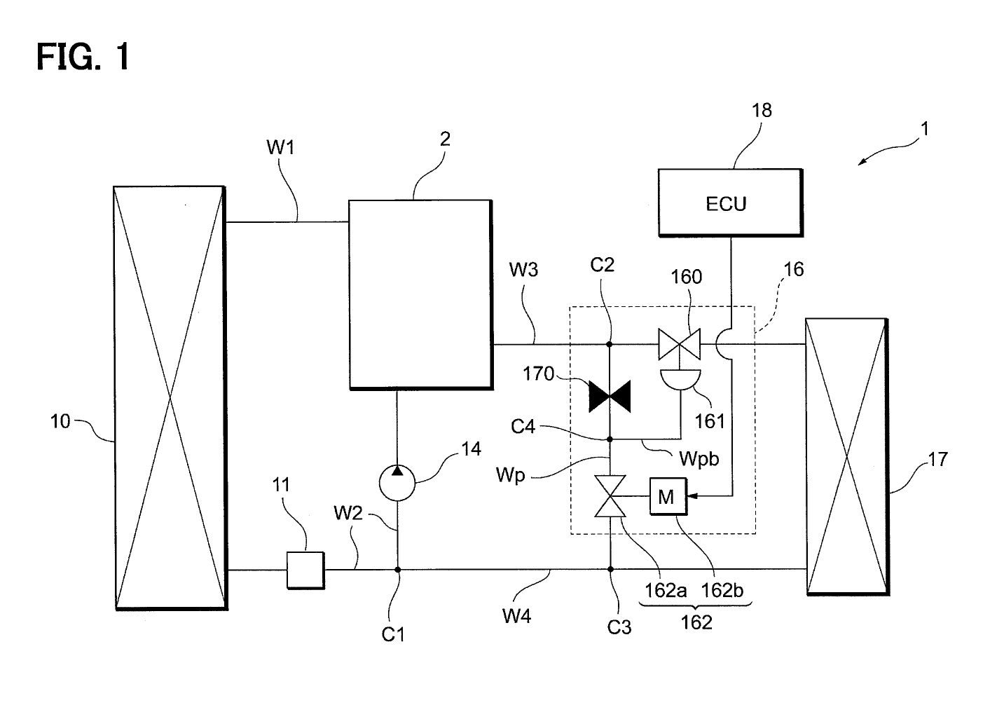

As shown in FIG. 1, the engine cooling system 1 of this embodiment includes a radiator 10, a thermostat 11, a pump 14, a pilot type opening-and-closing valve 16, a heater core 17, and an ECU (Electronic Control Unit) 18.

The radiator 10 is connected to the engine 2 through a first channel W1 and a second channel W2. A heat medium flows in the engine 2. The heat medium absorbs the heat of the engine 2 while flowing through the engine 2. The heat medium which absorbed the heat of the engine 2 circulates through a course returning to the engine 2 after passing through the first channel W1, the radiator 10, and the second channel W2. The radiator 10 cools the heat medium by performing heat exchange between the heat medium which flows through the inside of the radiator 10 and air which flows outside of the radiator 10 when the vehicle travels.

The heater core 17 is connected to the engine 2 through a third channel W3. In this embodiment, the heater core 17 corresponds to an apparatus, and the third channel W3 corresponds to a supply channel. The heater core 17 is connected to the second channel W2 through a fourth channel W4. In this embodiment, the fourth channel W4 corresponds to a discharge channel. According to such a structure, the heat medium which absorbed the heat of the engine 2 circulates through a course returning to the engine 2 after passing through the third channel W3, the heater core 17, the fourth channel W4, and the second channel W2. In the drawing, a mark C1 represents a connecting point of the fourth channel W4 and the second channel W2. The heater core 17 is disposed in an air passage of an air-conditioner, which is not illustrated, of the vehicle. The air passage is a passage for air to be sent into the vehicle interior. The heater core 17 heats the air by performing heat exchange between the air which flows through the air passage and the heat medium which flows through the heater core 17.

The pump 14 is arranged at a middle between the connecting point C1 and the engine 2 in the second channel W2. The pump 14 is a mechanical pump driven based on the power of the engine 2. That is, when the engine 2 is driven, the pump 14 is also driven. When the engine 2 stops, the pump 14 also stops. The pump 14 circulates the heat medium between the engine 2 and the radiator 10 and between the engine 2 and the heater core 17. That is, the pump 14 supplies the heat medium to the radiator 10 and the heater core 17.

The thermostat 11 is arranged at the middle between the radiator 10 and the connecting point C1 in the second channel W2. The thermostat 11 controls the flow of heat medium to the radiator 10 by opening and closing the second channel W2. For example, in a situation where the temperature of heat media is low, such as a time of cold starting the engine 2, the thermostat 11 is in the closed state. Therefore, the heat medium flows only through the heater core 17, without flowing through the radiator 10, such that the engine 2 can be quickly warmed. After the engine 2 is warmed such that the temperature of heat medium rises, the thermostat 11 is changed into the open state. Thereby, the heat medium flows through the radiator 10 and comes to be cooled.

The opening-and-closing valve 16 is arranged in the middle of the third channel W3. The opening-and-closing valve 16 controls the flow of heat medium to the heater core 17 by opening and closing the third channel W3. In detail, when the opening-and-closing valve 16 is in an open state, the heat medium is permitted to flow from the engine 2 to the heater core 17. When the opening-and-closing valve 16 is in a closed state, the flow of the heat medium from the engine 2 to the heater core 17 is intercepted.

ECU 18 controls the drive of the opening-and-closing valve 16. ECU 18 changes the opening-and-closing valve 16 into a closed state, for example, when warming the engine 2. Thereby, since the circulation of the heat medium between the engine 2 and the heater core 17 is intercepted, the engine 2 can be warmed quickly. As a result, the fuel consumption can be reduced.

In the air-conditioner, the temperature of air is raised with the heat emitted from the heater core 17, even when a cooling device of the air-conditioner is driven at the maximum cooling state, that is, when the opening degree of the air mixing door is adjusted so that the air does not flow through the heater core 17. In this case, since a compressor of the cooling device is driven to cancel the temperature increase in the air by the heater core 17, such that the temperature of air becomes equal to a preset temperature, the compressor may be operated in vain. Therefore, ECU 18 of this embodiment changes the opening-and-closing valve 16 into a closed state, when the cooling device is driven. Since heat exchange is hardly performed between the heater core 17 and the air, the air becomes not easily heated by the heater core 17. As a result, the compressor power of the cooling device can be restricted from getting worse.

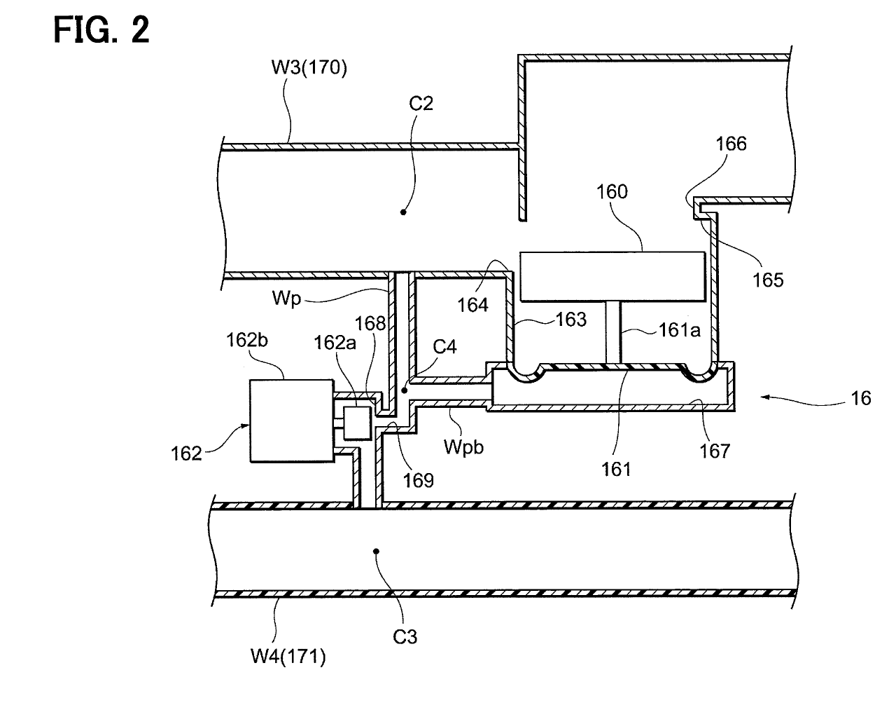

Next, the structure of the opening-and-closing valve 16 is explained in detail. As shown in FIG. 2, the opening-and-closing valve 16 includes a pilot channel Wp, a main valve 160, a diaphragm 161, and a pilot valve 162. The opening-and-closing valve 16 is integrally formed with a piping 170 which configures the third channel W3, and a piping 171 which configures the fourth channel W4.

The pilot channel Wp is provided to communicate the third channel W3 and the fourth channel W4 with each other. A connecting point of the third channel W3 and the pilot channel Wp is represented by an upstream side connecting point C2. Moreover, a connecting point of the fourth channel W4 and the pilot channel Wp is represented by a downstream side connecting point C3. The back pressure chamber 167 is defined in the pilot channel Wp, and is connected to a branch point C4 through a branch channel Wpb. The back pressure chamber 167 is a chamber portion shaped to have a passage diameter larger than that of the other channel portions of the pilot channel Wp. As shown in FIG. 1, a throttle 170 is disposed between the upstream side connecting point C2 and the branch point C4 in the pilot channel Wp.

As shown in FIG. 2, the main valve 160 is disposed in the middle of the third channel W3. In detail, a valve housing chamber 163 is formed in the middle of the third channel W3. The main valve 160 is housed in the valve housing chamber 163. An inflow port 164 of the main valve is formed in the side wall of the valve housing chamber 163 opposing the side of the main valve 160. A valve seat 165 is defined by the bottom wall of the valve housing chamber 163 opposing the bottom of the main valve 160. An outlet port 166 of the main valve passes through the valve seat 165. That is, the heat medium discharged from the engine 2 flows into the heater core 17 through the main valve inflow port 164, the valve housing chamber 163, and the main valve outlet port 166.

The main valve 160 closes the main valve outlet port 166 of the valve seat 165 by being seated on the valve seat 165. Thereby, the third channel W3 will be in a closed state. That is, the flow of the heat medium from the engine 2 to the heater core 17 is intercepted. When the main valve outlet port 166 of the valve seat 165 is closed by the main valve 160, the opening-and-closing valve 16 is also called as in the closed state.

The main valve 160 opens the main valve outlet port 166 of the valve seat 165 by separating from the valve seat 165. Thereby, the third channel W3 will be in an open state. That is, the flow of the heat medium from the engine 2 to the heater core 17 is permitted. When the main valve outlet port 166 of the valve seat 165 is opened by the main valve 160, the opening-and-closing valve 16 is also called as in the open state.

The diaphragm 161 is attached integrally to the main valve 160 through an axial part 161a. The diaphragm 161 is made of a component which has flexibility. The diaphragm 161 is arranged between the valve housing chamber 163 and the back pressure chamber 167, in other words, between the third channel W3 and the pilot channel Wp. A pressure receiving area of the diaphragm 161 adjacent to the back pressure chamber 167 is larger than a pressure receiving area of the diaphragm 161 adjacent to the main valve inflow port 164.

The pilot valve 162 consists of an electromagnetic valve. The pilot valve 162 includes a valve object 162a and an actuator 162b. The actuator 162b consists of an electromagnetic solenoid. The actuator 162b operates the valve object 162a based on the supplied power, to open and close a portion of the pilot channel Wp closer to the fourth channel W4 than the back pressure chamber 167.

In detail, a valve seat 168 is defined by a portion of the pilot channel Wp downstream of the branch point C4. The valve seat 168 has a through hole 169 communicated with the back pressure chamber 167. When the valve object 162a is seated on the valve seat 168 by the drive of the actuator 162b, the through hole 169 is closed. Thereby, the pilot channel Wp is in the closed state, and the flow of the heat medium from the third channel W3 and the back pressure chamber 167 to the fourth channel W4 is intercepted.

When the valve object 162a separates from the valve seat 168 by the drive of the actuator 162b, the through hole 169 is opened. Thereby, since the pilot channel Wp is in the open state, it enables the heat medium to flow into the fourth channel W4 from the third channel W3 and the back pressure chamber 167.

The closed state of the valve object 162a is also called as the closed state of the pilot valve 162, and the open state of the valve object 162a is also called as the open state of the pilot valve 162.

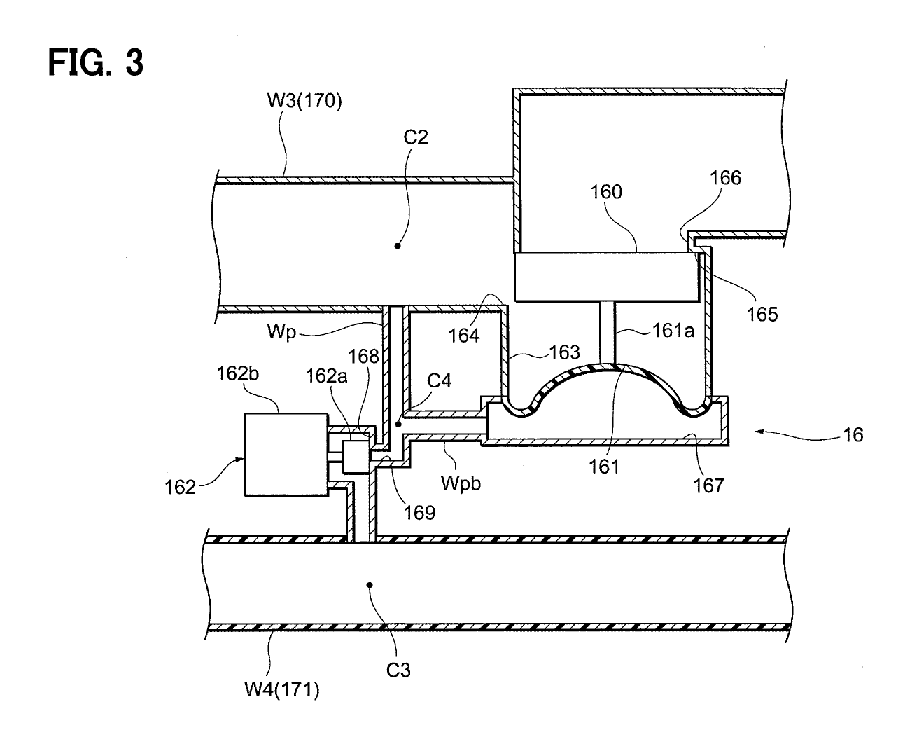

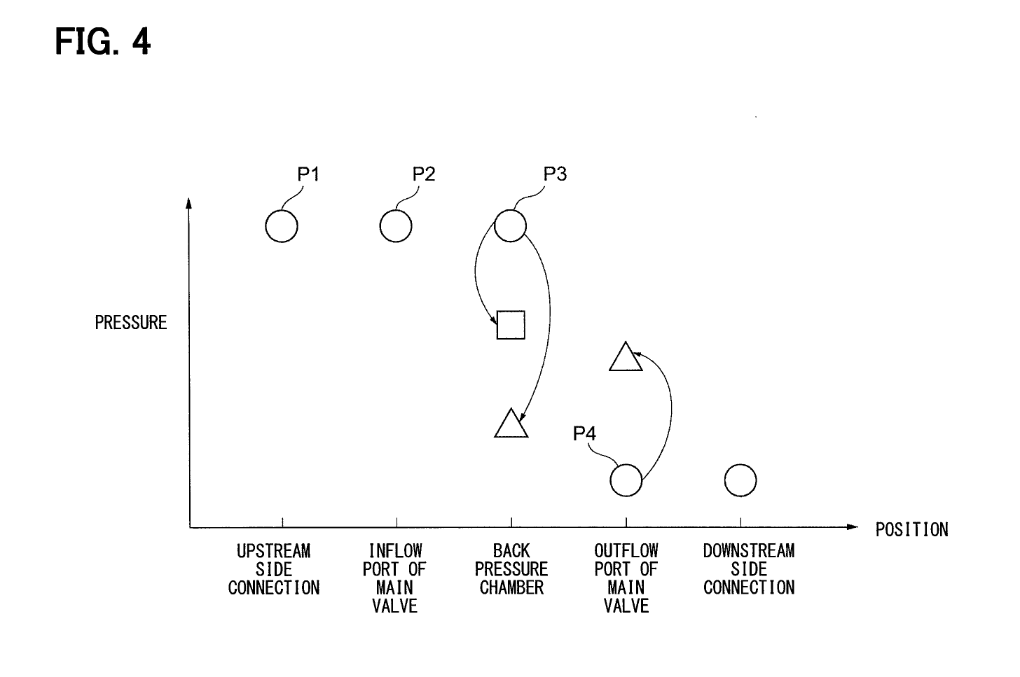

Next, an operation example of the opening-and-closing valve 16 of this embodiment is explained. In the situation where the pump 14 is driven, if the pilot valve 162 is in a closed state, the internal pressure P1 at the upstream side connecting point C2 of the third channel W3 is applied to the back pressure chamber 167. Under the present circumstances, since the internal pressure P2 of the inflow port 164 of the main valve and the internal pressure P3 of the back pressure chamber 167 are equal with each other, the equal pressure is applied to the surface of the diaphragm 161 adjacent to the main valve inflow port 164 and the surface of the diaphragm 161 adjacent to the back pressure chamber 167. Because the pressure receiving area of the diaphragm 161 adjacent to the back pressure chamber 167 is larger than the pressure receiving area of the diaphragm 161 adjacent to the main valve inflow port 164, the thrust force is added to the diaphragm 161 in a direction from the back pressure chamber 167 to the valve housing chamber 163. Due to the thrust force, as shown in FIG. 3, the diaphragm 161 is elastically deformed in the direction from the back pressure chamber 167 to the valve housing chamber 163, such that the opening-and-closing valve 16 is in the closed state. In this situation, the internal pressure P1 at the upstream side connecting point C2 of the third channel W3, the internal pressure P2 of the main valve inflow port 164, the internal pressure P3 of the back pressure chamber 167, the internal pressure P4 of the main valve outlet port 166, and the internal pressure P5 at the downstream side connecting point C3 of the fourth channel W4 have respective values represented by circles shown in FIG. 4.

Thus, in the situation where the opening-and-closing valve 16 is closed, ECU 18 opens the pilot valve 162 to open the opening-and-closing valve 16. Since a pressure according to a difference between the internal pressure P1 at the upstream side connecting point C2 of the third channel W3 and the internal pressure P5 at the downstream side connecting point C3 of the fourth channel W4 is applied to the back pressure chamber 167, the internal pressure P3 of the back pressure chamber 167 is lowered to a value represented by a triangle of FIG. 4 from the value represented by the circle of FIG. 4. Then, since the internal pressure P2 of the main valve inflow port 164 is higher than the internal pressure P3 of the back pressure chamber 167, the thrust force is applied to the diaphragm 161 in the direction from the valve housing chamber 163 to the back pressure chamber 167. Due to this thrust force, as shown in FIG. 2, the diaphragm 161 is elastically deformed in the direction from the valve housing chamber 163 to the back pressure chamber 167, such that the opening-and-closing valve 16 is in the open state.

Moreover, when the opening-and-closing valve 16 is made in the open state, the heat medium comes to flow through the third channel W3. Then, as shown in FIG. 4, the internal pressure P4 of the main valve outlet port 166 rises from the value of the circle to a value of a triangle. Under the present circumstances, a pressure difference arises between the internal pressure P4 of the main valve outlet port 166 and the internal pressure P5 at the downstream side connecting point C3 of the fourth channel W4, according to the resistance of the heater core 17 to water flow.

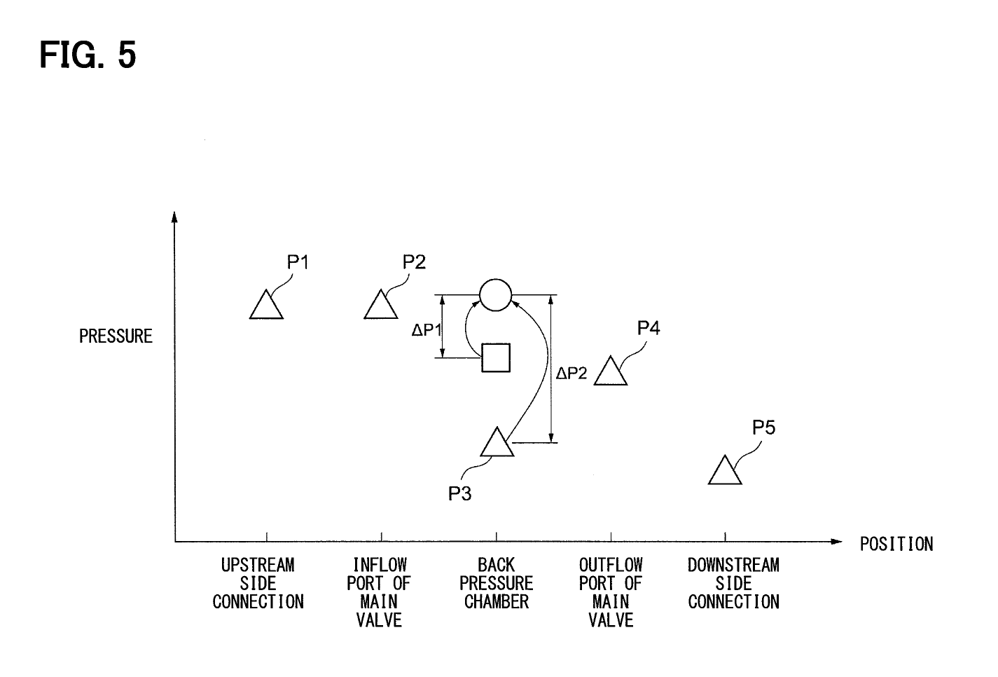

When the opening-and-closing valve 16 is in the open state, the internal pressure P1 at the upstream side connecting point C2 of the third channel W3, the internal pressure P2 of the main valve inflow port 164, the internal pressure P3 of the back pressure chamber 167, the internal pressure P4 of the main valve outlet port 166, and the internal pressure P5 at the downstream side connecting point C3 of the fourth channel W4 have respective values represented by triangles shown in FIG. 5. Thus, in the situation where the opening-and-closing valve 16 is open, ECU 18 closes the pilot valve 162 to close the opening-and-closing valve 16. Thereby, since the internal pressure P1 at the upstream side connecting point C2 of the third channel W3 is applied to the back pressure chamber 167, the internal pressure P3 of the back pressure chamber 167 changes from the value of the triangle to a value of a circle shown in FIG. 5. That is, the internal pressure P3 of the back pressure chamber 167 rises. Since the internal pressure P2 of the main valve inflow port 164 and the internal pressure P3 of the back pressure chamber 167 become equal to each other, the thrust force is added to the diaphragm 161 in the direction from the back pressure chamber 167 to the valve housing chamber 163, based on the difference between the pressure receiving area of the diaphragm 161 adjacent to the main valve inflow port 164 and the pressure receiving area of the diaphragm 161 adjacent to the back pressure chamber 167. Due to this thrust force, as shown in FIG. 4, the diaphragm 161 is elastically deformed in the direction from the back pressure chamber 167 to the valve housing chamber 163, such that the opening-and-closing valve 16 is in the closed state.

According to the flowpath structure of the engine cooling system 1 of this embodiment, the action and effect described in the following (1)-(3) can be acquired.

(1) The third channel W3 and the fourth channel W4 are communicated with each other by the pilot channel Wp. The pilot valve 162 opens and closes a portion of the pilot channel Wp adjacent to the fourth channel W4 than the back pressure chamber 167. The main valve 160 opens and closes the third channel W3 based on change in the internal pressure of the back pressure chamber 167 caused by the opening-and-closing operation of the pilot valve 162.

Accordingly, since the heater core 17 acts as resistance to water flow, the internal pressure of the fourth channel W4 becomes higher than the internal pressure of the third channel W3. Therefore, the internal pressure P3 of the back pressure chamber 167 can be reduced at the time of opening the pilot valve 162, compared with the case where the heater core 17 does not exist.

Specifically, if supposing the heater core 17 does not exist, when the pilot valve 162 is opened, the internal pressure P3 of the back pressure chamber 167 has a value represented by a square in FIG. 5, according to a difference between the internal pressure P2 of the main valve inflow port 164 and the internal pressure P4 of the main valve outlet port 166. In contrast, in the opening-and-closing valve 16 of this embodiment, when the pilot valve 162 is opened, the internal pressure P3 of the back pressure chamber 167 has the value represented by the triangle in FIG. 5, according to the difference between the internal pressure P1 at the upstream side connecting point C2 of the third channel W3 and the internal pressure P5 at the downstream side connecting point C3 of the fourth channel W4. That is, the internal pressure P3 of the back pressure chamber 167 can be lowered at the time of opening the pilot valve 162 by the resistance of the heater core 17 to water flow, compared with the case where the heater core 17 does not exist. Thereby, the change in the pressure of the back pressure chamber 167 caused by the pilot valve 162 operated to close from the open state has a value of “ΔP2” larger than “ΔP1” in case where the heater core 17 does not exist. As a result, the force added to the diaphragm 161 can be changed more greatly. In other words, since the force added to the main valve 160 can be more greatly changed, the opening-and-closing operation of the opening-and-closing valve 16 can be performed more appropriately in the situation where the output of the pump 14 declines, such as idling operation time.

If supposing the heater core 17 does not exist, when the pilot valve 162 opens, the internal pressure P3 of the back pressure chamber 167 has a value represented by a square in FIG. 4, according to a difference between the internal pressure P2 of the main valve inflow port 164 represented by the circle, and the internal pressure P4 of the main valve outlet port 166 represented by the triangle. Therefore, when the pilot valve 162 operates to open from the closed state, the internal pressure P3 of the back pressure chamber 167 is changed only by “ΔP3.” In contrast, according to the opening-and-closing valve 16 of this embodiment, when the pilot valve 162 is opened, since the internal pressure P5, which is low-pressure at the downstream side connecting point C3 of the fourth channel W4 is applied to the back pressure chamber 167, the internal pressure P3 of the back pressure chamber 167 has the value represented by the triangle smaller than the value of the square. Therefore, when the pilot valve 162 is operated to open from the closed state, the internal pressure P3 of the back pressure chamber 167 is changed only by “ΔP4.” That is, compared with the case where the heater core 17 does not exist, according to the opening-and-closing valve 16 of this embodiment, the internal pressure P3 of the back pressure chamber 167 is changed more sharply when the pilot valve 162 opens from the closed state. As a result, the opening-and-closing valve can be more appropriately closed.

(2) The opening-and-closing valve 16 has the diaphragm 161 integrally formed with the main valve 160 at the location between the third channel W3 and the back pressure chamber 167. Thereby, the opening-and-closing operation of the main valve 160 can be carried out easily based on the change in the internal pressure P3 of the back pressure chamber 167 caused by the opening-and-closing operation of the pilot valve 162.

(3) The opening-and-closing valve 16 is united with the piping 170 which forms the third channel W3, and the piping 171 which forms the fourth channel W4. Thereby, the opening-and-closing valve 16 can be assembled more easily to the piping 170 and the piping 171.

In addition, the embodiment can also be implemented with the following forms.

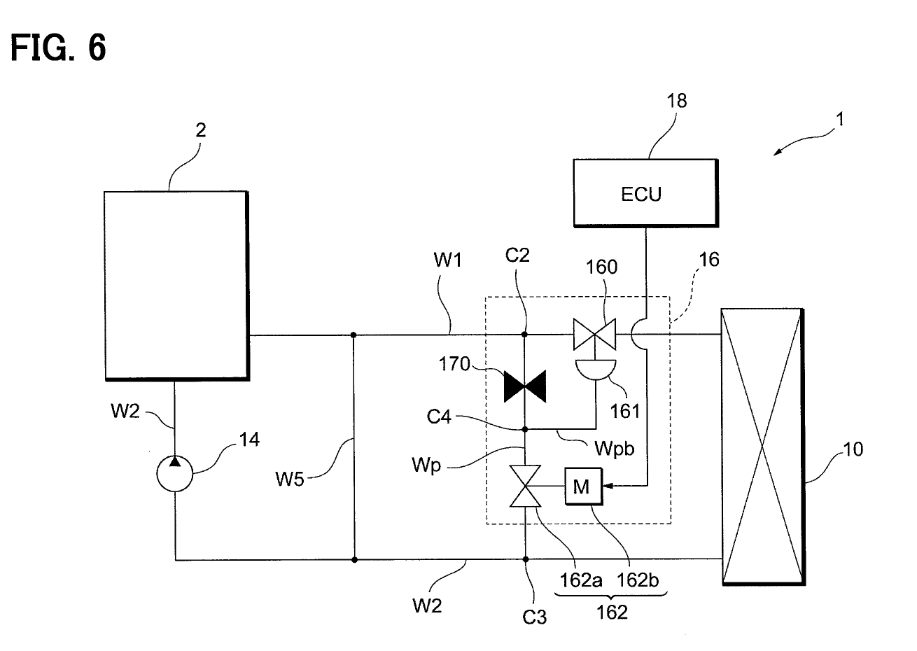

As shown in FIG. 6, the heat medium may circulate only between the engine 2 and the radiator 10 in the engine cooling system 1. In detail, in the engine cooling system 1 shown in FIG. 6, the pilot type opening-and-closing valve 16 is formed in the first channel W1. The pilot channel Wp communicates the first channel W1 and the second channel W2 with each other. Moreover, the engine cooling system 1 further has a fifth channel W5 in addition to the pilot channel Wp, to communicate the first channel W1 and the second channel W2 with each other. In this engine cooling system 1, the radiator 10 corresponds to an apparatus. Moreover, the first channel W1 corresponds to a supply channel, and the second channel W2 corresponds a discharge channel. In this engine cooling system 1, when ECU 18 closes the pilot valve 162, the opening-and-closing valve 16 is in a closed state. Therefore, the flow of the heat medium from the engine 2 to the radiator 10 is intercepted. In this case, the heat medium discharged from the engine 2 returns to the engine 2 through the fifth channel W5 and the second channel W2, without flowing through the radiator 10. That is, the heat medium short-circuits the engine 2. Thereby, the engine 2 can be warmed quickly. Moreover, when ECU 18 opens the pilot valve 162, the opening-and-closing valve 16 is in the open state. Therefore, the engine 2 can be cooled effectively since the heat medium circulates between the engine 2 and the radiator 10. The action and effect according to the embodiment can be acquired with such a configuration.

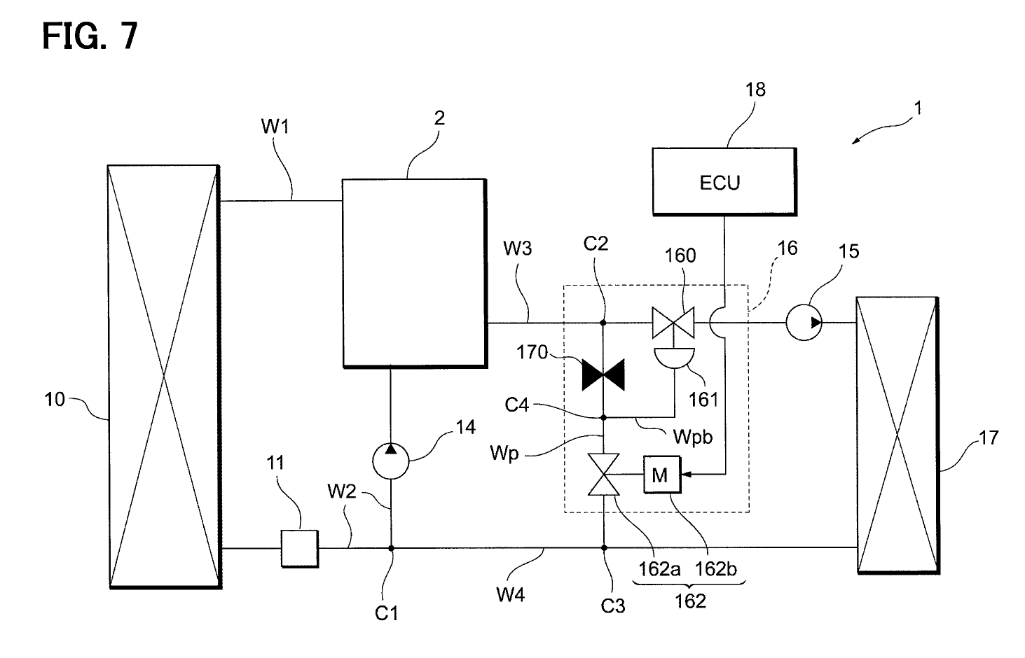

As shown in FIG. 7, the engine cooling system 1 may further has a pump 15 between the opening-and-closing valve 16 and the heater core 17 in the third channel W3. The pump 15 may be a mechanical pump driven by the power of the engine 2, or an electric pump driven by electric power of an in-vehicle battery. The pump 15 is disposed, for example, to adjust the flow rate of the heat medium which flows into the heater core 17 from the engine 2.

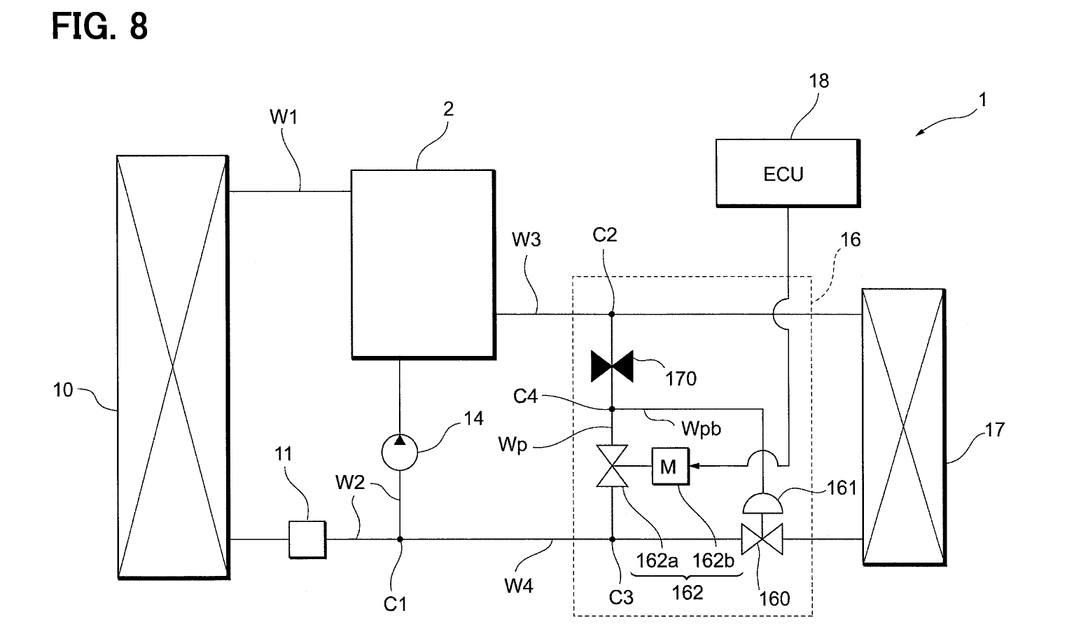

As shown in FIG. 8, the main valve 160 of the opening-and-closing valve 16 may be arranged not in the third channel W3 which is a supply channel but in the fourth channel W4 that is a discharge channel. Namely, the opening-and-closing valve 16 is arranged in either one of the supply channel and the discharge channel.

The pump 14 may be an electric pump driven by electric power of an in-vehicle battery, without limited to a mechanical pump.

The pilot valve 162 may be not only an electromagnetic valve but a motor drive valve.

The opening-and-closing valve 16 is not limited to have the diaphragm 161 while the main valve 160 is operated to open and close by a change in the internal pressure of the back pressure chamber 167.

The opening-and-closing valve 16 may be used as a flow rate regulating valve which adjusts the flow rate of heat medium by adjusting the valve travel of the main valve 160.

The main heat source apparatus for heating the heat medium may be not only the engine 2 but an inverter, an electric heater and the like.

The flowpath structure of the embodiment may be applied to various kinds of cooling and heating water systems, such as a refrigerating cycle, without being limited to the flowpath structure for the heat exchange cycle of the engine 2. Moreover, the apparatus in which the flow of heat medium is controlled by the opening-and-closing operation of the opening-and-closing valve 16 may be changed suitably according to the flowpath structure of the cooling and heating water system. The apparatus for this kind of cooling and heating water system may include a heat exchanger for cooling or heating oil of an automatic shift, a heat exchanger for cooling a motor generator, an EGR cooler, a heat exchanger for cooling or heating an in-vehicle battery, an intercooler for supercharging, a radiator, a cooler core, and the like. Moreover, fluid other than the heat medium may be used depending on the configuration of the flowpath structure.

The present disclosure is not limited to the above examples. A design change by a person skilled in the art is included within the range of the present disclosure as long as having the features of the present disclosure. Each element and its arrangement, condition, form, and the like are not necessarily limited to each example mentioned above, and can be changed suitably. The elements of the embodiments can be combined appropriately unless a combination is technically impossible.

What is claimed is:

1. A flowpath structure comprising:
a supply channel in which a fluid to be supplied to an apparatus flows;
a discharge channel in which the fluid discharged from the apparatus flows; and
a pilot type opening-and-closing valve disposed in either one channel of the supply channel and the discharge channel, wherein
the opening-and-closing valve has
a main valve arranged in the either one channel,
a pilot channel connecting the supply channel and the discharge channel with each other, a back pressure chamber being defined in the pilot channel, and
a pilot valve that opens and closes a portion of the pilot channel closer to the discharge channel than the back pressure chamber, and
the main valve opens and closes the either one channel based on a change in an internal pressure of the back pressure chamber caused by an opening-and-closing operation of the pilot valve.

2. The flowpath structure according to claim 1, wherein
the opening-and-closing valve further has a diaphragm arranged between the either one channel and the back pressure chamber, integrally with the main valve.

3. The flowpath structure according to claim 1, further comprising: a pump which supplies the fluid to the apparatus through the supply channel.

4. The flowpath structure according to claim 1, wherein
the opening-and-closing valve integrally has a piping which defines the supply channel, and a piping which defines the discharge channel.

5. The flowpath structure according to claim 1, wherein
the apparatus is in a cooling-and-heating water system for a vehicle.

6. The flowpath structure according to claim 1, wherein
the apparatus is in a system for cooling an engine of a vehicle, and the fluid is a heat medium which cools the engine of the vehicle.
